(19) United States
(12) Patent Application Publication
(10) Pub. No.: US 2019/0211287 A1
(43) Pub. Date: Jul. 11, 2019

(54) MULTI-PURPOSE CLEANING SOLUTION

(71) Applicant: Penny J. Gilmer, Tallahassee, FL (US)

(72) Inventor: Penny J. Gilmer, Tallahassee, FL (US)

(21) Appl. No.: 16/240,056

(22) Filed: Jan. 4, 2019

Related U.S. Application Data
(60) Provisional application No. 62/613,971, filed on Jan. 5, 2018.

(51) Int. Cl. C11D 9/26; C11D 9/08

(52) U.S. Cl. CPC C11D 9/26; C11D 11/0035; C11D 9/08

(57) ABSTRACT

Disclosed herein is a multi-purpose cleaning solution, wherein the solution comprises vinegar, ammonia, alcohol, and a surfactant. Ammonium acetate forms in the chemical reaction. The multi-purpose cleaning concentrate can be diluted with water.

### CROSS-REFERENCE TO RELATED APPLICATIONS

This application claims benefit of U.S. Provisional Application No. 62/613,971, filed Jan. 5, 2018, incorporated herein by reference in its entirety.

### BACKGROUND

So-called natural multi-purpose cleaners and fresheners known in the art are, in fact, not always all natural. Rather, these multi-purpose cleaners and fresheners claiming to be natural are not completely free of harmful chemical components. Previous multi-purpose cleaners and fresheners, even if largely comprised of natural ingredients, often include at least one or more synthetic ingredients that result in an unknown or detrimental effect on the human body or the environment. These potentially harmful ingredients may include, for example, an amount of synthetic chemical for cleaning, emulsification, fragrance or stabilization. Additionally, due to the components of known multi-purpose cleaners, these cleaners may leave behind an unpleasant odor that remains long after the cleaning process is complete. Furthermore, many of the so-called natural products on the marker are not particularly effective at cleaning.

What is needed in the art is a natural, effective, multi-purpose cleaning solution. The present invention provides such as solution.

### SUMMARY

Disclosed herein is a multi-purpose cleaning composition, said cleaning composition comprising: (a) about 16-21% to volume isopropyl alcohol; (b) about 1-3% by volume vinegar; (c) about 1-4% by volume ammonia; (d) about 0.01 to 2% by volume of at least one pre-selected surfactant; (e) about 69-79.99% by volume of water.

Further disclosed herein is a multi-purpose cleaning composition concentrate to be mixed with water, said multi-purpose cleaning compound concentrate comprising between about 75% to about 84% by volume isopropyl alcohol, between about 8% to about 12% by volume vinegar, between about 4% and about 6% by volume ammonia, and between about 1% and about 3% by volume of at least one pre-selected surfactant.

### DETAILED DESCRIPTION

### OBJECTS OF THE INVENTION

It is one of the primary objects of the present invention to provide a natural, effective cleaning solution, which has multiple uses.

Another object of the present invention is to provide a cleaning solution, which can be used on a plurality of different surfaces including, glass, linoleum, tile, plastic, ceramic, melamine, porcelain, and stone.

Still another object of the present invention is to provide a cleaning solution, which will minimize the number of products required to clean different surfaces.

Yet another object of the present invention is to provide a cleaning solution, which will reduce the storage space requirements.

A further object of the present invention is to provide a cleaning solution, which will save time and energy for the person doing the cleaning.

Still yet another object of the present invention is to provide a cleaning solution, which is economical to produce.

A still further object of the present invention is to provide a cleaning solution, which has a pleasant aroma.

It is another object of the present invention to provide a cleaning solution, which is effective in removing mold and mildew.

Another object of the present invention is to provide a cleaning solution that can be used on automotive surfaces, such as car exteriors, and interior glass, without damages.

Still another object of the present invention is to provide an environmentally friendly multi-purpose cleaning solution for use both indoors and outdoors.

Yet still another object of the present invention to provide a cleaning solution, which can be supplied as either a ready to use mixture or as a concentrate to be mixed with a predetermined amount of water.

In addition to the various objects and advantages of the present invention which have been described with some degree of specificity above it should be obvious that additional objects and advantages of the present invention will become more readily apparent to those persons who are skilled in the relevant art from the following more detailed description of the invention, particularly, when such description is taken in conjunction with the appended claims.

### BRIEF DESCRIPTION OF A PRESENTLY PREFERRED AND VARIOUS ALTERNATIVE EMBODIMENTS OF THE INVENTION

As mentioned above, the present invention can be commercially produced as either a concentrated solution that should be diluted with water before use or as a ready to use solution that can be used straight from the product's container.

Disclosed herein is a multi-purpose cleaning composition, said cleaning composition comprising: (a) about 16-21% to volume isopropyl alcohol; (b) about 1-3% by volume vinegar; (c) about 1-4% by volume ammonia; (d) about 0.01 to 2% by volume of at least one surfactant; and (e) about 69-79.99% by volume of water.

The isopropyl alcohol to be used in the present composition can be at any commercially available concentration. For example, it can be 100% isopropyl alcohol, 91% isopropyl alcohol, 70% isopropyl alcohol, or 50% isopropyl alcohol. One of skill in the art will be able to adjust the amount of isopropyl alcohol used in the composition based on the concentration of the isopropyl alcohol. For example, when 91% isopropyl alcohol is used, the ready to use solution can comprise 19.1% by volume. When 100% isopropyl alcohol is used, it can comprise 17.4% by volume.

The vinegar used in the composition described herein can be any commercially available vinegar. For example, the vinegar can be white vinegar. The vinegar can comprise 2.4% by volume.

The ammonia used in the composition described herein can be any commercially available ammonia, such as clear ammonia. Alternatively, the ammonia can be lemon-scented, or any other natural scent. For example, the ammonia can comprise 1.2% by volume.

The surfactant used in the composition described herein can be any commercially available surfactant. For example, the surfactant can be common dish soap. The dish soap can be natural and organic, for example, but any available dish soap can be used. For example, the dish soap can comprise 0.61% by volume.

The multi-purpose cleaning composition described herein can be provided in a concentrated form, which can be mixed with water to bring it up to the desired concentration/volume. The multi-purpose cleaning compound concentrate comprising between about 75% to about 84% by volume isopropyl alcohol, between about 8% to about 12% by volume vinegar, between about 4% and about 6% by volume ammonia, and between about 1% and about 3% by volume of at least one pre-selected surfactant.

When the composition is provided in concentrated form, one example of the amounts provided can be 91% isopropyl alcohol, comprising 82% by volume. White vinegar can comprise 10.2% by volume. Ammonia can comprise 5.2% by volume. The surfactant (such as dish soap) can comprise 2.6% by volume.

### EXAMPLES

The following is provided by way of example, and is not intended to be limiting. The composition can be produced using the following procedure:

In a small bucket, mix together the following:
2 quarts (or 1893 mL) of warm water
2 cups (or 472 mL) 91% isopropyl alcohol
⅛ cup (or 30 mL) of clear ammonia (10%)
¼ cup (or 59 mL) of white vinegar (5%)
1 Tablespoon (or 15 mL) of liquid detergent
Total volume is 2,469 mL

Gently mix the ingredients (preferably in this order) together and pour into suitable bottles, such as spray bottles. To clean glass, spray the glass with the mixture, then remove the liquid with a double-wrap scrub assist netting on an auto squeegee, and rinse with fresh water. The water can be removed similarly. Alternatively, remove the liquid both times with a microfiber cloth. A clay bar with the mixture can be used to remove a cloudy surface on the headlights of an automobile or a truck.

All components and products are water-soluble.

Chemical reaction of weak base (NH₄OH) plus weak acid (HC₂H₃O₂) yields a salt, in this case, ammonium acetate (NH₄(C₂H₃O₂), plus water (H₂O):

NH₄OH_{(aq)}+H(C₂H₃O₂)_{(aq)}<−>NH₄(C₂H₃O₂)_{(aq)}+H₂O (1)

Any excess ammonia or acetic acid will evaporate, leaving no trace. Any excess ammonium acetate, NH₄(C₂H₃O₂), will sublimate (i.e., change from solid to gas), leaving no trace.

This formulation can be used for shower glass, shower stalls, outdoor windows, indoor windows, auto/truck glass windows, automobile and truck headlights, eyeglasses, sunglasses, mobile devises (like iPads, iPhones, other cellular phones or tablets), computer screens, TV screens, jewelry, watches, white-boards, solar cells, solar panels, oven surfaces, microwave surfaces, refrigerator surfaces, Conan surfaces, stone and ceramic tiles, and stone counter tops.

The formula described herein is also effective as a multi-purpose cleaner for cleaning dirt and grime from all types of surfaces including venetian blinds, shades, and doors. It could also be used on hard surfaces, such as appliances, walls, floors, Formica, vinyl, and wood panels.

It will be apparent to those skilled in the art that various modifications and variations can be made in the present disclosure without departing from the scope or spirit of the invention. Other embodiments of the disclosure will be apparent to those skilled in the art from consideration of the specification and practice of the methods disclosed herein. It is intended that the specification and examples be considered as exemplary only, with a true scope and spirit of the invention being indicated by the above claims.

What is claimed is:

1. A multi-purpose cleaning composition, said cleaning composition comprising:
(a) about 16-21% to volume isopropyl alcohol;
(b) about 1-3% by volume vinegar;
(c) about 1-3% by volume ammonia;
(d) about 0.01 to 2% by volume of at least one surfactant;
(e) about 69-79.99% by volume of water.

2. The multi-purpose cleaning composition of claim 1, wherein the isopropyl alcohol is 91% isopropyl alcohol.

3. The multi-purpose cleaning composition of claim 2, wherein the 91% isopropyl alcohol comprises 19.1% by volume.

4. The multi-purpose cleaning composition of claim 1, wherein the isopropyl alcohol is 100% isopropyl alcohol.

5. The multi-purpose cleaning composition of claim 4, wherein the 100% isopropyl alcohol comprises 17.4% by volume.

6. The multi-purpose cleaning composition of claim 1, wherein said vinegar is 5% white vinegar.

7. The multi-purpose cleaning composition of claim 6, wherein said white vinegar comprises 2.4% by volume.

8. The multi-purpose cleaning composition of claim 1, wherein said 10% ammonia comprises 1.2% by volume.

9. The multi-purpose cleaning composition of claim 1, wherein said surfactant comprises 0.61% by volume.

10. The multi-purpose cleaning composition of claim 9, wherein said surfactant is dish soap.

11. A multi-purpose cleaning composition concentrate to be mixed with water, said multi-purpose cleaning compound concentrate comprising between about 75% to about 84% by volume isopropyl alcohol, between about 8% to about 12% by volume vinegar, between about 3% and about 6% by volume ammonia, and between about 1% and about 3% by volume of at least one pre-selected surfactant.

12. The multi-purpose cleaning composition of claim 11, wherein the isopropyl alcohol is 91% isopropyl alcohol.

13. The multi-purpose cleaning composition of claim 12, wherein the 91% isopropyl alcohol comprises 82% by volume.

14. The multi-purpose cleaning composition of claim 11, wherein said vinegar is 5% white vinegar.

15. The multi-purpose cleaning composition of claim 14, wherein said white vinegar comprises 10.2% by volume.

16. The multi-purpose cleaning composition of claim 11, where said ammonia is 10% ammonia.

17. The multi-purpose cleaning composition of claim 16, wherein said ammonia comprises 5.2% by volume.

18. The multi-purpose cleaning composition of claim 11, wherein said surfactant comprises 2.6% by volume.

19. The multi-purpose cleaning composition of claim 18, wherein said surfactant is dish soap.
